(19) United States
(12) Patent Application Publication
(10) Pub. No.: US 2012/0010739 A1
(43) Pub. Date: Jan. 12, 2012

(54) Design configurator system

(75) Inventor: Henri-Claude Elisma, Laval (CA)

(73) Assignee: C&D Zodiac, Inc., Huntington Beach, CA (US)

(21) Appl. No.: 13/064,248

(22) Filed: Mar. 14, 2011

Related U.S. Application Data
(60) Provisional application No. 61/315,562, filed on Mar. 19, 2010.

(51) Int. Cl. G06F 17/50; G06F 19/00

(52) U.S. Cl. 700/98

(57) ABSTRACT

The present invention relates to design and configuration engineering and more particularly to providing a Configurator system that automates aspects of the engineering design process. The Configurator System automates the configuration engineering process associated with creating new designs for customers based on a catalog of pre-designed options and can generate 2D drawings and 3D models necessary to manufacture the product in an automated fashion.

### CROSS-REFERENCE TO RELATED APPLICATION

This application claims the benefit of U.S. Provisional Patent Application No. 61/315,562, filed on Mar. 19, 2010, entitled “CONFIGURATION SYSTEM”. The foregoing application is hereby entirely incorporated by reference.

### FIELD OF THE INVENTION

The invention relates to design and configuration engineering. In particular, the invention provides a system to semi-automate the design process in configuration engineering.

### BACKGROUND OF THE INVENTION

In certain applications, product design is highly individualized and depends on the particular needs of a specific customer. These are referred to as “custom” designs and are designed for a particular set of specifications making each manufactured product unique. In custom designs, since an array of product variations and flavors are offered to the customer, typically no two products are the same. In contrast to mass production system where a single design is used for the manufacturing of hundreds and thousands of products, in custom work, a design is used for a single product or a small quantity of manufactures. As such, the time and effort spent of each design directly adds to the cost and time necessary for the life cycle of a single product. In mass production, this design time and cost is amortized amongst the thousands of manufactures and becomes a small part of the expense of each product. But in custom design due to the small number of products manufactured from each design the cost and time cannot be amortized in this way.

Without the use of the Configurator, the best and most prevalent method known for custom design is to manually and methodically create two dimensional drawings (“2D”) and three dimensional models (“3D”) for engineering designs. The engineer would receive specifications for the design and would then create 2D drawings and 3D models, for example on a CAD system or by hand. This process requires long, repetitive engineering hours. Due to its labor intensiveness, it is also expensive.

Furthermore, in custom design, Companies with a quality product with an interesting pallet of options are more attractive to customers. Providing additional options and design flexibility further complicates the design process, intensifies labor, and thus increases cost. Therefore, marketability in these fields is affected by the companies' ability to optimize between available options and design costs. Thus, if a company can increase available options and design flexibility while keeping costs under control, the company can gain a definite market advantage.

In the past, as a way to reduce the labor and increase design efficiency, there have been various attempts to create automated design systems but none have been successful in fulfilling the need in the art for an automated system that efficiently produces custom designs. This need remains particularly pronounced in the mechanical disciplines where custom mechanical designs are produced.

### SUMMARY OF THE INVENTION

The invention relates to design and configuration engineering and more particularly to providing a Configurator system that automates aspects of the engineering design process.

The Design Configurator System automates the configuration engineering process associated with creating new designs for customers based on a catalog of pre-designed options. With a set of input choices by the customer, the designer will use the Design Configurator System to create the engineering product structure, 2D drawings and 3D models necessary to manufacture the product and to deliver to the customer. The uniqueness of the Design Configurator System is based on its intelligence to re-use existing drawings and models from the database where possible, and to create new drawings and models on the fly. This feature permits reuse of design work already performed and as such increases efficiency.

The features of this system involve the relationship between each of the principal components of the system: Databases, File Server, Application Server, and custom built interfaces. The results obtained are the efficiencies associated with rapid automated configuration of 2D drawings and 3D models data, based upon an external specification input. The Design Configurator System has the unique ability to utilize a separate database to govern the history of designs, and therefore control the re-use of existing data as well as new data generation.

The Design Configurator System is based upon a design philosophy, custom built VB (Visual Basic) code, SQL databases, and off-the-shelf products to support CAD (Computer Aided Drafting) and PDM (Product Data Management). The VB code acts as the interface and engine between each of the systems. The result is the synchronization between a list of configurable items and the associated 3D geometry.

Through its features, the Design Configurator System automates creation of designs, promotes reuseability, enhanced user flexibility and friendliness, and enhances execution speeds. The system enables exportability, that is, renders a tool that is useable for any product being designed. The Design Configurator System improves cost savings as measured by the reduction of hours required for repetitive configuration engineering. The re-use of existing engineering models and drawings contributes to savings in engineering hours, manufacturing programming time, in-house stores and stockroom, certification, etc.

### BRIEF DESCRIPTION OF THE DRAWINGS

FIG. 1 shows an overview of one embodiment of the system.

FIG. 2 shows an embodiment of an interface of the engine of the Configurator System.

FIG. 3 shows an example of an interface through which configurable options can be selected.

FIG. 4 shows an example of an interface through which a design tree generates a Bill of Materials.

FIG. 5 shows a three-dimensional model created by the Configurator System.

FIG. 6 shows a two-dimensional drawing generated through the Configurator System.

FIG. 7 shows an example of an interface through which new configurable options can be added.

### DETAILED DESCRIPTION OF THE INVENTION

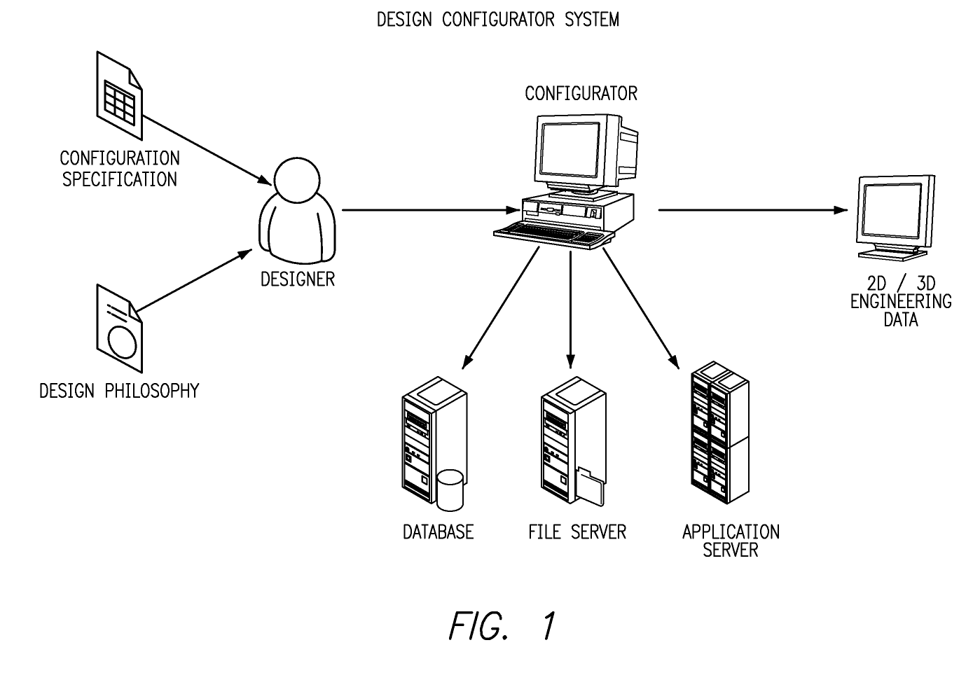

FIG. 1 provides a high level overview of the system. In FIG. 1, the interactions of the designer with the various components of the system are shown. The designer must understand the product design, the options, the parts that compose the product, and how those parts interact. These concepts are embodied by the “configuration specification” as shown in FIG. 1. The designer also needs to choose and apply a design philosophy. An example of such a philosophy is modular design philosophy. Based on the configuration specification and the design philosophy, the designer interacts with the Configurator system to create designs. The Configurator's main system and the peripheral units that interact with it are symbolically shown in FIG. 1. The central computer shown represents the Configurator engine. Connected to this engine is a database, a file server, and an application server. Product templates, discussed more fully below, may be located on the file server. The file server may additionally include all other information relating to a product including new configuration files, parts lists, etc. The file server works with the application server and together to provide, for example, a PDM as discussed above. A CAD system, symbolically shown as 2D/3D Engineering Data in FIG. 1, may also interface with the engine. Information is bidirectionally communicated between the engine and the database, file server, application server, and the CAD system.

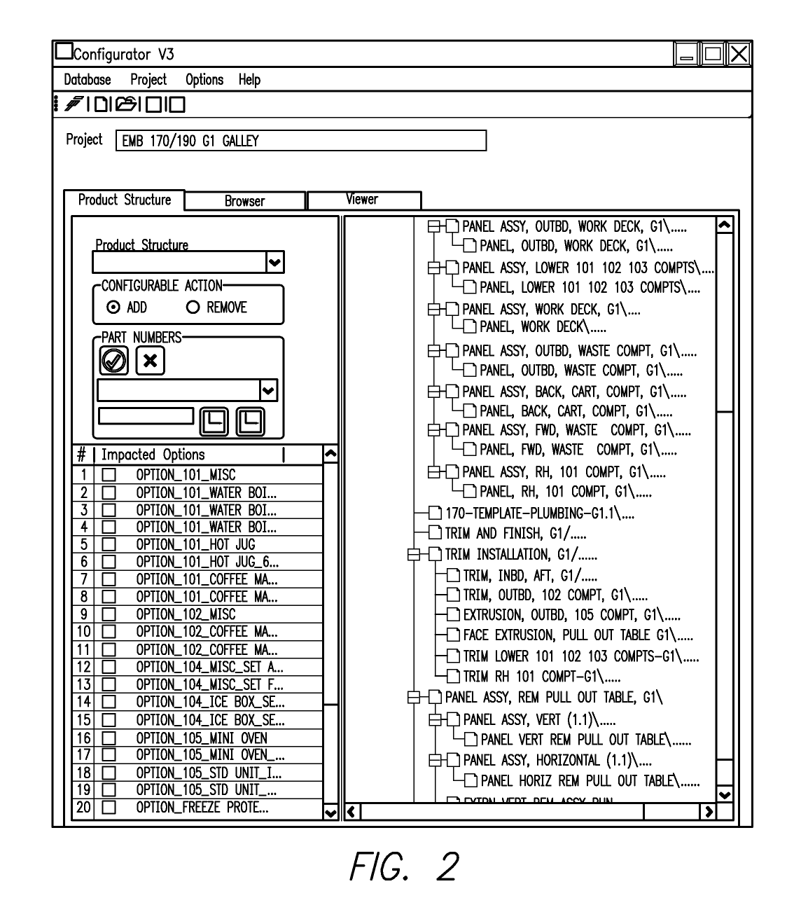

FIG. 2 shows an interface of the Configurator engine. The first tab seen in the figure is the Product Structure screen. The Product Structure is the sum of all of the items that compose a product. For example, consider a vessel galley. In this example, it is named “G1 assembly.” G1 assembly may have a product structure that includes panel assemblies, trim kit, etc. Some of these composing items are shown in the right panel of FIG. 2. The Product Structure, thus, is a set of all of the items that compose that product and can be stored, for example, in the Configurator database. The stored Product Structure is an exact replication or a subset of the one that can be found in the PLM system or in the CAD file of the corresponding product.

To set up the Configurator system on a product, the designer has to first create 3D model templates and 2D drawing templates (typically in the CAD system), then create a project (with the Configurator engine), and lastly he will be able to build new design configurations. Once templates and projects are set up, from the Configurator's interface, the designer can then select options and enter appropriate part numbers when required for various configurable items consistent with a custom design. The engine automatically reuses part numbers of past design configurations when possible to avoid part number proliferation and sub-designs duplication. After having entered those part numbers, the system can, in an automated fashion, create a new custom design based on the selected options and entered part numbers. From this new design, 3D models, 2D drawings, and a BOM can be generated. The models, drawings, and BOM are then used to manufacture the product. In this way, aspects of the new product design have become automated and the benefits of the Configurator realized.

Initially, the designer creates templates of the relevant product. This can be performed, for example, in the CAD system. Templates are typically 3D model templates and 2D drawing templates, and a product will usually have multiple 2D drawing templates. These templates are typically made following a precise methodology based on modular design, and they may include all of the items in the product structure for that product. They may include the configurable options as well. Additionally, the designer also identifies which ones of items of the product constitute configurable options and which ones do not. For example, one or more of the items in the G1 assembly, for example the trim kit, may be configurable options. Configurable item CAD files which constitute templates can be stored in the PDM system and accessed by the Configurator through the CAD system.

After the templates have been created, the designer can then set up the project. The project is set up by creating a project with the Configurator engine. A name is given to the project. In the example above, the project is called “G1 assembly.” FIG. 2 shows an interface of the Configurator, where the template for the G1 assembly product structure discussed above has been selected from the CAD System and imported into the Configurator. The right side panel in FIG. 2 shows a partial menu of the list of items in the G1 assembly template. The left side panel shows various options that can be selected for the G1 assembly. Multiple items can be imported simultaneously into the Configurator. The items may be selected and imported, for example, from a template loaded into the CAD system, by clicking on the items with the right mouse button and selecting “import” from a menu of functions.

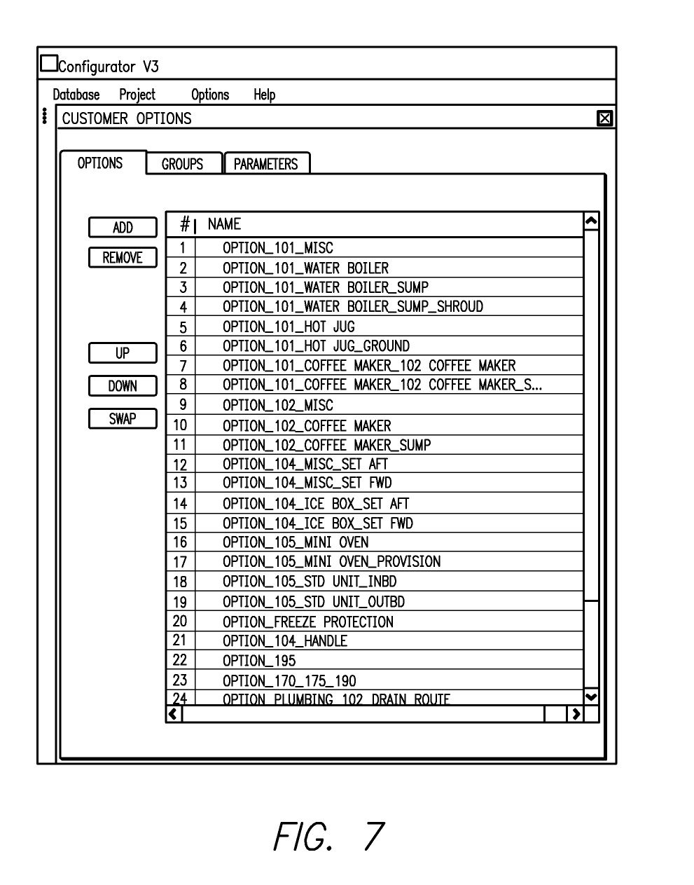

If the designer wishes to create, change or modify configurable options, the designer can do so. In one embodiment, a menu choice can be provided that navigates the designer to the proper interface for affecting such a change. In one example as shown in FIG. 2, if the menu choice “options” in the top menu bar is selected, the designer can choose to modify the options and be directed to an interface shown for example by FIG. 7. Using command buttons present on the options interface, shown in FIG. 7, is one way to modify available options.

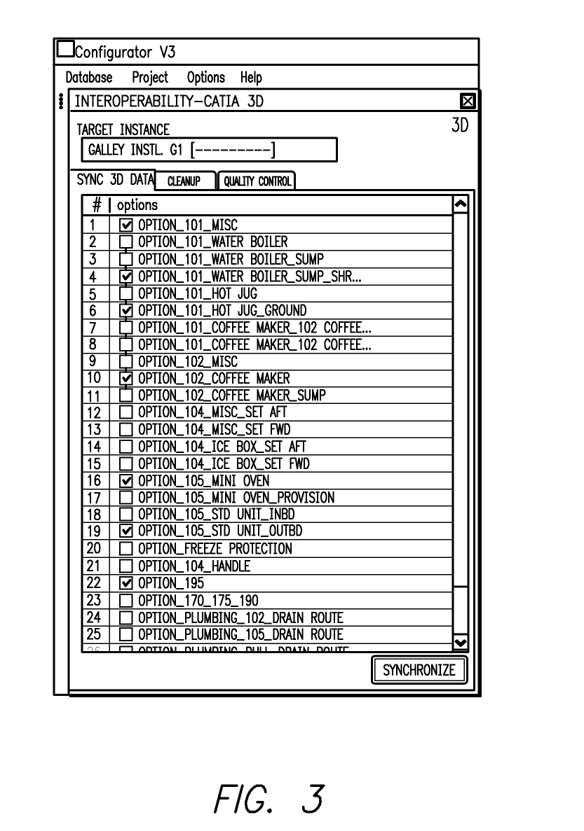

Once the template is created, items are imported and options are defined into the Configurator, the designer is ready to build the new designs. The designer may set available options according to new design configuration specifications. FIG. 3 shows an interface to set options for new product designs. As can be seen from the figure, boxes identifying the options can be selected by the designer.

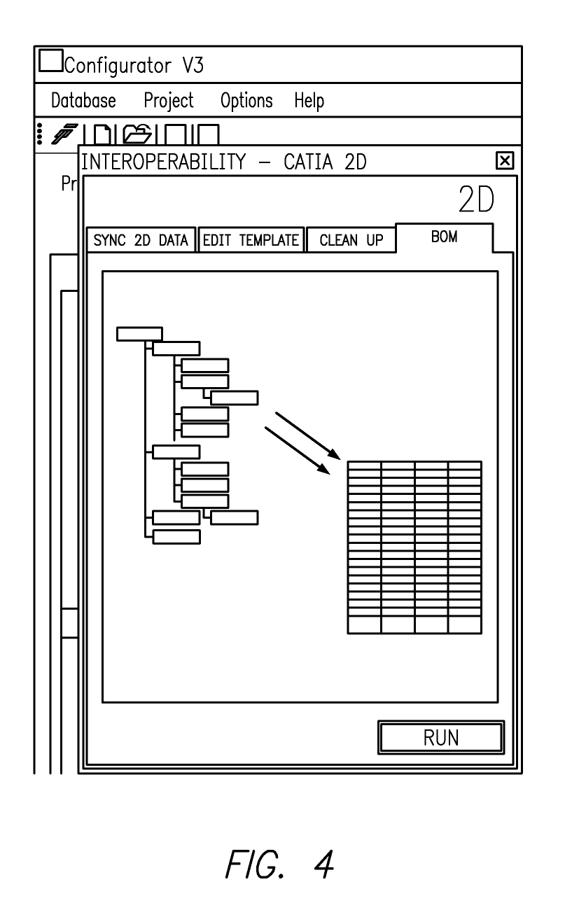

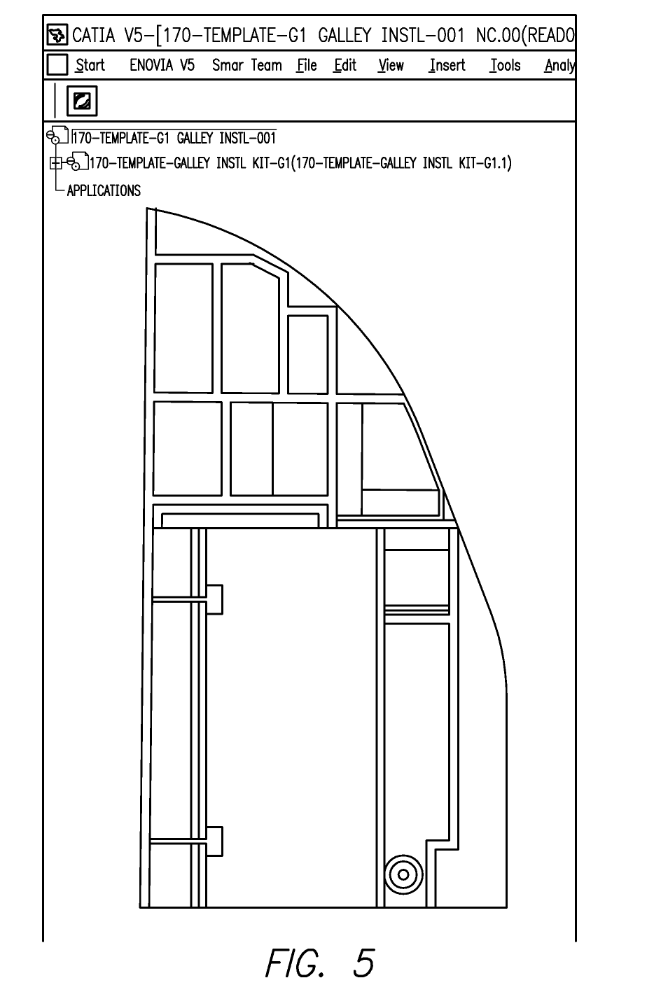

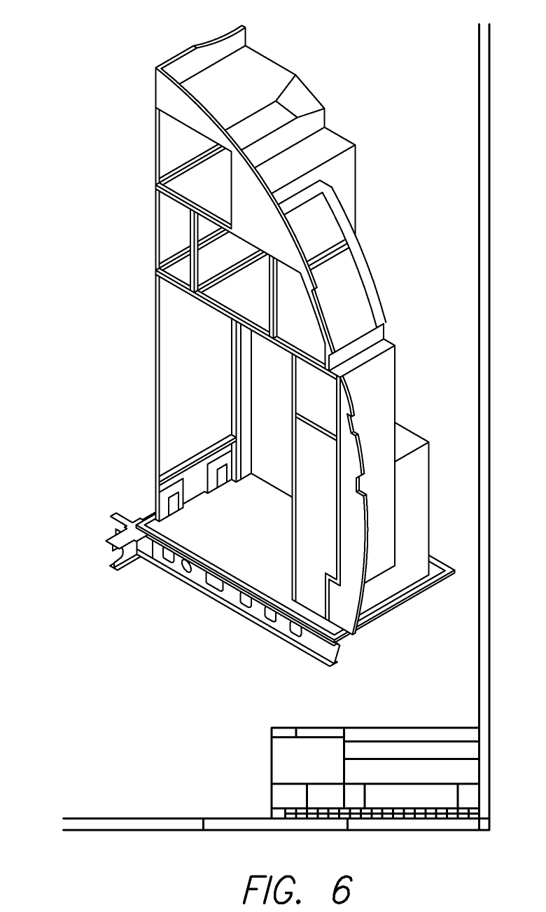

Once the options are selected, the designer may define relevant part numbers for the items requiring it. At this point, the designer is ready to synchronize all of the information relating to a product design. In one embodiment, the system will synchronize the information to build the 3D model. FIG. 5 is one example of a 3D model of the G1 assembly. The system is also able to synthesize a 2D drawing from the 3D model. An example of the 2D drawing for the G1 assembly is shown in FIG. 6. After the drawing is created, the designer can interface with the system to automatically generate a BOM. FIG. 4 shows an interface through which such synchronization can, for example, be initiated.

As such, catalogs of products with available options represent the offer that the manufacturer can present to the customer for their custom design. If the manufacturers desire to offer additional products or different options, new templates or options can be created according to the process above. Once a configuration specification is received, the designer will locate the appropriate templates and use the Configurator engine to build to create a new configuration. For example as shown in FIG. 2 where this information has been provided for the G1 assembly. The designer then selects the options. As, for example, shown by FIG. 3. The designer will then use the Configurator to generate the 3D model, 2D drawing, and BOM in an automated fashion as discussed above.

The Configurator uses a modular approach to design. Each configurable option is in effect a module. The modules must be created and designed. But by focusing design efforts on constructions of modules, the Configurator achieves reusability in a systematic fashion which was not available before. By selection of the appropriate modules consistent with the customer's design, the design of the complete product can be accomplished with speed and efficiency. And because many options can be configured and available as modules, the choices and options presented to the customer can be increased while significantly limiting design costs. This affords added flexibility and cost savings to the design process.

The foregoing descriptions of the specification of the present invention are presented for purposes of illustration and description. They are not intended to be exhaustive or to limit the invention to the precise forms disclosed. Obviously, many modifications and variations are possible in view of the above teachings. For example, many software and hardware products are available that can be used to provide the Configurator engine, databases, servers, and CAD and PDM systems. Additionally, the Configurator can be used for custom designs in a wide variety of applications. Further still, the particulars of the interface, the underlying program, or the order of the operations can be changed to meet the needs of the individual user or the system as long as the requirements of the claims are satisfied. While the embodiments were chosen and described in order to best explain the principles of the invention and its practical applications, thereby enabling others skilled in the art to best utilize the invention, various embodiments with various modifications as are suited to the particular use are also possible. The scope of the invention is to be defined only by the claims and their equivalents.

We claim:

1. A method of creating a design used to manufacture a product by creating a product structure by the following steps:
(a) creating a template for the product;
(b) identifying all configurable options in the template;
wherein selection of the options will enable automated creation of a 3D model, a 2D drawing, or a bill of materials for the product;
wherein the 3D model, 2D drawing, and BOM can be used to manufacture the product.

2. The method of claim 1 further comprising synchronizing the template and selected options with a drafting system to thereby generate said 2D engineering drawings.

3. The method according to claim 1 wherein further new configurable options are added to the system and said new configurable options will appear in a menu of available options.

4. A method according to claim 1 wherein all information necessary to generate said engineering drawings is communicated to the drafting system in an automated fashion.

5. A system for designing an engineering structure used to manufacture a product comprising
a Configurator for receiving a set of inputs representing options for a design;
a drafting system to interface with the Configurator and in which templates for the product can be created;
a database in communication with the Configurator and the drafting system that stores information useable by the Configurator;
wherein configurable options for said product have been selected from a list of available options;
wherein information from the template and the selected configurable options generate 2D drawings in automated fashion;
and wherein the drawings can be used to manufacture the product.

6. The system according to claim 5 wherein said manufactured product is consistent with said selected configurable options.

7. The system according to claim 5 wherein new available options can be added to said list of available options.

8. The system according to claim 5 wherein an application server interfaces with the Configurator.

9. The system according to claim 5 wherein a file server interfaces with the Configurator.
